(19) United States
(12) Patent Application Publication
(10) Pub. No.: US 2013/0300533 A1
(43) Pub. Date: Nov. 14, 2013

(54) Ceramic Multilayered Component and Method for Producing a Ceramic Multilayered Component

(71) Applicants: Gerhard Bisplinghoff, Deutschlandsberg (AT); Christian Hesse, Deutschlandsberg (AT); Gerald Kloiber, Feldkirchen (AT)

(72) Inventors: Gerhard Bisplinghoff, Deutschlandsberg (AT); Christian Hesse, Deutschlandsberg (AT); Gerald Kloiber, Feldkirchen (AT)

(73) Assignee: EPCOS AG, Muenchen (DE)

(21) Appl. No.: 13/882,661

(22) PCT Filed: Oct. 27, 2011
(86) PCT No.: PCT/EP11/68891

§ 371 Date: Jul. 22, 2013

(30) Foreign Application Priority Data
Nov. 3, 2010 (DE) 10 2010 050 370.3

(51) Int. Cl. H01C 7/00; H01C 17/00

(52) U.S. Cl. CPC H01C 7/008; H01C 17/00
USPC 338/22 R; 29/612

(57) ABSTRACT

A ceramic multilayered component which includes a layer stack having a plurality of ceramic layers. The multilayered component includes a first and a second connecting contact as well as a first and a second inner electrode, which are each arranged between two layers of the layer stack. The multilayered component includes a first and a second via electrode for electrically coupling the first connecting contact to the first inner electrode and for electrically coupling the second connecting contact to the second inner electrode.

This patent application is a national phase filing under section 371 of PCT/EP2011/068891, filed Oct. 27, 2011, which claims the priority of German patent application 10 2010 050 370.3, filed Nov. 3, 2010, each of which is incorporated herein by reference in its entirety.

### TECHNICAL FIELD

The invention relates to a ceramic multilayered component, and to a method for producing such a ceramic multilayered component.

### BACKGROUND

NTC ceramics (negative temperature coefficient thermistor) can be used as temperature sensors, for example. They are relatively low-resistance semiconductors which can be used to determine a temperature relatively simply by means of measuring the electrical resistance.

### SUMMARY OF THE INVENTION

A ceramic multilayered component and a method for producing such a ceramic multilayered component with low resistances can be realized. Furthermore, the multilayered component can be well protected relative to external environmental influences. Furthermore, it is desirable for the resistance value of the multilayered component can be exactly settable.

In one embodiment of the invention, a ceramic multilayered component comprises a layer stack comprising a plurality of ceramic layers. Preferably, the ceramic multilayered component is embodied as a thermistor in which the ceramic layers comprise one or a plurality of NTC or PTC ceramics, for example. The ceramic multilayered component furthermore comprises a first and a second connection contact. A first and a second internal electrode are arranged between in each case two layers of the layer stack. The ceramic multilayered component comprises a first via electrode for electrically coupling the first connection contact with the first internal electrode and a second via electrode for electrically coupling the second connection contact to the second internal electrode.

With a construction of this type, an active region, which primarily predefines the electrical properties of the multilayered component, can be shifted into the interior of the component. Electrical contact is made with the active region by way of the internal electrodes situated in the interior of the component. Electrical contact is in turn made with the internal electrodes externally by means of the connection contacts by way of the via electrodes.

For a predefined component size, for example, the electrical resistance of the component can be reduced since the distance between the internal electrodes, which are primarily decisive for the electrical resistance, is reduced. Conventionally, the electrodes which make contact with the active region of the component are fitted at the outer areas of the component, for example, where the connection contacts are arranged according to the invention. Furthermore, the internal electrodes, since they are enclosed by at least two ceramic layers in each case, are well protected relative to environmental influences, such as moisture, for example. Reliable operation of the multilayered component is thus made possible.

In exemplary embodiments, the connection contacts are arranged at opposite surfaces of the layer stack. In further exemplary embodiments, the connection contacts are arranged on a common surface. In these exemplary embodiments, if the two connection contacts are arranged on the same surface of the layer stack, the component can be coupled well, for example, to printed circuit boards.

Preferably, the ceramic multilayered component is designed for electrical contact-linking by means of wires. In particular, the multilayered component can be embodied as a wired component. By way of example, the ceramic multilayered component can have conductive connections in the form of wires. Said conductive connections are preferably electrically conductively connected to the connection contacts by means of a soldering and/or welding process, such that electrical contact can be made with the ceramic multilayered component externally by means of the conductive connections. By way of example, the conductive connections can be embodied as connection wires comprising a metal, such as, e.g., copper or nickel. The connection wires can have different diameters. Furthermore, the conductive connections can also be embodied as so-called leadframes. The ceramic multilayered component can be designed in such a way that it is suitable neither for surface mounting (SMD component) nor for flip-chip mounting.

In one embodiment of a method for producing a ceramic multilayered component, at least one first ceramic layer is provided. A first internal electrode is applied to the at least one first ceramic layer. At least one second ceramic layer is applied to the first internal electrode. A second internal electrode is applied to the at least one second ceramic layer. At least one third ceramic layer is applied to the second internal electrode. A first via electrode through the at least one first ceramic layer to the first internal electrode is formed. A second via electrode through the at least one third ceramic layer to the second internal electrode is formed. A connection contact is arranged per via electrode, such that electrical contact can in each case be made with the internal electrodes.

In embodiments, a part of the layer stack is removed after arranging the connection contacts in a manner dependent on a predefined property of the component. By way of example, a part of the layer stack is ground away transversely with respect to the layer direction in order to set the electrical resistance to a predefined value.

### BRIEF DESCRIPTION OF THE DRAWINGS

Further advantages, features and developments will become apparent from the following examples explained in conjunction with the figures. Elements that are identical, of identical type and act identically may be provided with the same reference signs in the figures. The illustrated elements and their size relationships with respect to one another should not be regarded as true to scale, in principle; rather, individual elements, such as layers or regions, for example, may be illustrated with exaggerated thickness or size dimensions in order to enable better illustration and/or in order to afford a better understanding.

FIG. 1 shows a schematic illustration of a ceramic multilayered component in accordance with one embodiment;

FIG. 2 shows a schematic illustration of a multilayered component in accordance with one embodiment;

FIG. 3 shows a schematic illustration of a multilayered component in accordance with one embodiment; and

FIG. 4 shows a schematic illustration of a multilayered component in accordance with one embodiment.

### DETAILED DESCRIPTION OF ILLUSTRATIVE EMBODIMENTS

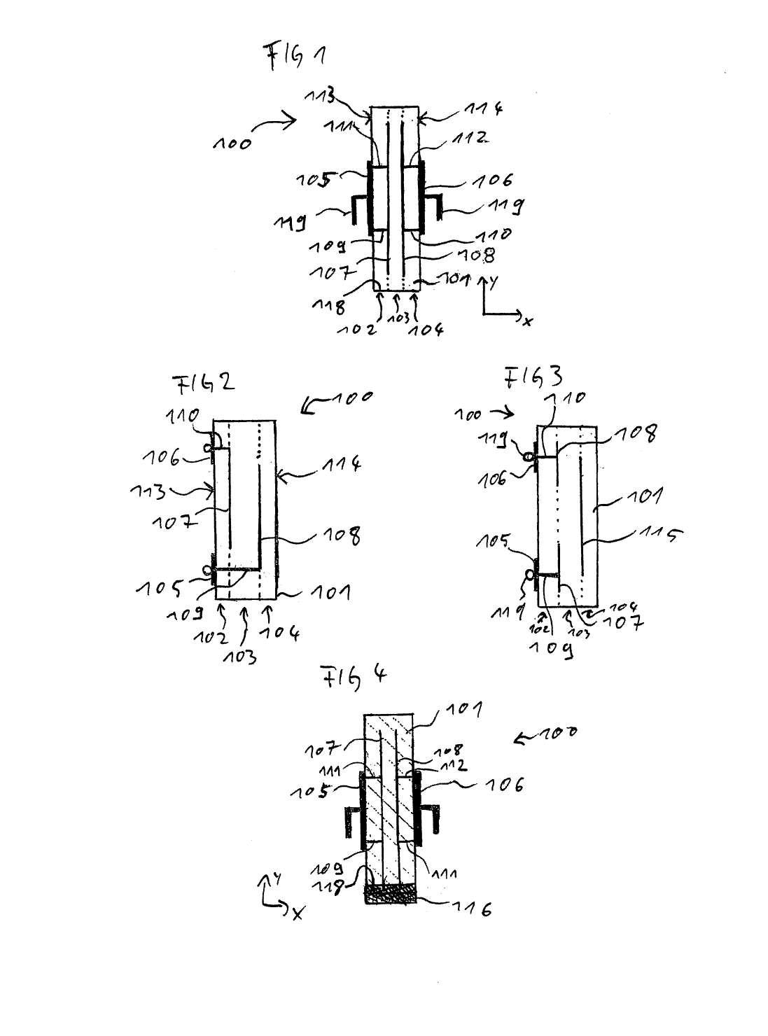

FIG. 1 shows a ceramic multilayered component 100 in cross section, this component being embodied as a thermistor component. The ceramic multilayered component 100 comprises a plurality of ceramic layers 102, 103 and 104, which can each in turn comprise a plurality of partial layers. The ceramic layers 102, 103 and 104 are stacked one on top of another to form a layer stack 101. In particular, the ceramic layers 102, 103 and 104 each comprise an NTC ceramic. Alternatively, the ceramic layers 102, 103 and 104 can each comprise a PTC ceramic.

A first internal electrode 107 is arranged between the layer 102 and the layer 103. A second internal electrode 108 is arranged between the layer 103 and the layer 104. The internal electrodes 107 and 108 each extend transversely with respect to the stacking direction (X-direction) areally extensively over virtually the entire area of the layers 102 and 103, and 104 and 103 respectively. The internal electrodes 107 and 108 cover the layers 102 and 104, respectively, only partly and not completely. In embodiments, the internal electrodes 107 and 108 cover the layers 102 and 104, respectively, over the whole area.

From outside the layer stack, in particular from a first areally extensive surface 113 of the layer 102 and an opposite areally extensive surface 114 of the layer 104, in each case via electrodes 109, 111 and 110, 112, respectively, extend transversely with respect to the stacking direction to the respectively closer internal electrodes. The via electrodes 109 and 111 extend, beginning at that outer main area of the layer stack 101 which is closest to the internal electrode 107, through the ceramic layer 102 to the internal electrode 107. The via electrodes 110 and 112 extend, beginning at a second main area of the layer stack, said second main area being closest to the internal electrode 108, through the ceramic layer 104 as far as the internal electrode 108.

A connection contact 105 is arranged at the surface 113 for the purpose of making electrical contact with the component, said connection contact being electrically coupled to the via electrodes 109 and 110. A further connection contact 106 is arranged on the surface 114, said further connection contact being electrically coupled to the via electrodes 110 and 112.

During operation, electrical contact is made with the component at the connection contacts 105 and 106 by means of contacts 119. The contacts 119 can be embodied as connection wires or leadframes, for example. The connection wires or leadframes are preferably mechanically and electrically conductively connected to the connection contacts 105, 106 by means of a soldering and/or welding process and serve for making electrical contact with the component. The contacts 119 project away from the layer stack 101. Electrical contact is made with the active region of the component, which is primarily arranged between the two internal electrodes 107 and 108, by way of the internal electrodes 107 and 108, which are in turn electrically coupled to the respectively associated connection contact by way of the via electrodes.

By virtue of the fact that the internal electrodes 107 and 108 are arranged in the interior of the ceramic layer stack 101, electrical properties of the component 100 have become independent of the external dimensions of the component 100. The distance in the X-direction between the internal electrode 107 and the internal electrode 108 can be varied, the external dimensions of the component 100 remaining the same. By way of example, the electrical resistance or the characteristic curve of the NTC component is predefined by way of the distance between the two internal electrodes 107 and 108. Thus, very small resistances are realized for predefined external dimensions.

The internal electrodes 107 and 108 are protected against environmental influences since they are arranged in the interior of the layer stack 101. The internal electrodes 107 and 108 are protected by the ceramic layers between which they are respectively arranged. Since the internal electrodes 107 and 108 are each embedded between two ceramic layers and have a smaller area content than the ceramic layers 102, 103 and 104, that is to say do not reach as far as the outer edges of the component, for example, a side area 118 running transversely with respect to the surfaces 113 and 114, internal electrodes are securely coupled to the adjacent ceramic layers. The internal electrodes do not reach as far as the side areas of the layer stack. The risk of the internal electrodes becoming detached from the adjacent ceramic layers, for example, owing to moisture penetrating in, is prevented or at least reduced.

Thus, in particular, operation is improved over the entire operating time of the component since the electrical resistance changes only little over the operating time.

The internal electrodes 107 and 108 can in each case be coupled to the respective connection contacts by more than two via electrodes; in embodiments, the internal electrodes 107 and 108 are in each case electrically coupled to the associated connection contact by only one via electrode.

In embodiments, the ceramic layers 102, 103 and 104 comprise the same ceramic material. In further embodiments, the ceramic layers 102, 103 and 104 comprise mutually different ceramic materials. Furthermore, parts of the layer stack 101 can comprise the same ceramic material, for example, the layers 102 and 104, and a further part of the layer stack can comprise a ceramic different therefrom, for example the layer 103.

FIG. 2 shows a further embodiment of the component 100. In contrast to the exemplary embodiment in FIG. 1, the connection contacts 105 and 106 are arranged on a common surface 113 of the layer stack 101. Moreover, the internal electrodes 107 and 108 are electrically coupled to a respective one of the connection contacts 105, 106 in each case by way of a single via electrode 109 and 111, respectively.

Since the internal electrodes 107 and 108, which make contact with the active region of the component 100, are arranged in the interior of the layer stack 101, components with which contact can be made on one side can be formed. A single planar main area of the ceramic layer 102 has two connection contacts 105 and 106. Beginning at the connection contact 106, the via electrode 110 extends through the ceramic layer 102 as far as the internal electrode 107 and electrically couples the latter to the connection contact 106. Beginning at the connection contact 105, the via electrode 109 extends through the ceramic layer 102 and the ceramic layer 103 as far as the internal electrode 108 and electrically couples the latter to the connection contact 105. In projection in the stacking direction, the internal electrodes 107 and 108 partly overlap and each have a further part that does not overlap. Such components with which contact can be made on one side can be coupled well to printed circuit boards, for example.

FIG. 3 shows a further embodiment of the component 100. As in the exemplary embodiment in accordance with FIG. 2, the connection contacts 105 and 106 are arranged on a single side of the layer stack. In contrast to the previous exemplary embodiments, the two internal electrodes 107 and 108 are arranged between the same ceramic layers 102 and 103. The internal electrodes 107 and 108 are arranged in the same plane of the layer stack and have no overlapping regions in projection in the stacking direction. The via electrodes 109 and 110 for making electrical contact between the internal electrodes 107 and 108, respectively, and the respectively associated connection contact 105 and 106, respectively, extend in each case only through the ceramic layer 102. A further internal electrode 115 is arranged between the ceramic layers 103 and 104, contact to outside the component not being made with said further internal electrode. Such an internal electrode is also called a floating electrode.

FIG. 4 shows a further embodiment of the component 100 comparable with the embodiment in FIG. 1, in which a part 116 of the layer stack 101 has been removed. By removing the part 116 of the layer stack 101, a fine setting of the electrical properties of the component 100, for example, of the electrical resistance, is carried out. In particular, the part 116 is removed by grinding away the layer stack 101 transversely with respect to the stacking direction.

Since no external electrode but rather only internal electrodes are arranged in the region 116 that is removed for adjusting the electrical properties to predefined values, the adjustment to the predefined properties is possible in a precise manner. By reducing the size of at least one of the internal electrodes, the resistance of the component 100 is settable. As far as possible no conductive material, for example, material of the internal electrodes 107, 108, is spread by the grinding process, and the accuracy of the adjustment is high as a result.

The region 116 is ground away in particular after the completion of the component, that is to say after the ceramic layers 102, 103 and 104 have been stacked alternately with the internal electrodes 107 and 108 one on top of another, the via electrodes have been formed, for example, introduced by stamping and filled with electrically conductive material, and the connection contacts 105 and 106 have been applied. The component can thereupon be subjected to a test and, in the case of deviations of the electrical properties from the predefined values, the region 116 can be removed from the layer stack 101 in a manner dependent on the deviation, in order to set the predefined value of the electrical property in a precise manner. In embodiments, the side area 118, in particular the ends of the internal electrodes 107 and 108 that are exposed after the grinding-away process, are sealed in order to reduce or prevent the risk of a short circuit and to protect the component against environmental influences.

1-13. (canceled)

14. A ceramic multilayered component, comprising:
a layer stack comprising a plurality of ceramic layers:
a first connection contact;
a second connection contact;
a first internal electrode and a second internal electrode, arranged between two layers of the layer stack;
a first via electrode electrically coupling the first connection contact to the first internal electrode; and
a second via electrode electrically coupling the second connection contact to the second internal electrode.

15. The ceramic multilayered component according to claim 14, wherein the first connection contact is arranged at a surface of the layer stack and the second connection contact is arranged at an opposite surface, and wherein an area of the first connection contact is smaller than an area of the surface and wherein an area of the second connection contact is smaller than an area of the opposite surface.

16. The ceramic multilayered component according to claim 14, wherein the first and the second connection contacts are arranged at a common surface of the layer stack and wherein the area of the first and second connection contacts taken together is smaller than an area of the common surface.

17. The ceramic multilayered component according to claim 14, wherein the internal electrodes are each smaller in projection in a stacking direction of a last stack than the projection of the layer stack.

18. The ceramic multilayered component according to claim 14, wherein the internal electrodes are in contact with a respective one of the ceramic layers in each case at two opposite main areas.

19. The ceramic multilayered component according to claim 14, further comprising a third internal electrode.

20. The ceramic multilayered component according to claim 14, when the component is embodied as a thermistor.

21. The ceramic multilayered component according to claim 14, where the component is embodied as a wired component.

22. The ceramic multilayered component according to claim 14, further comprising a connection wire connected to one of the connection contacts.

23. A method for producing a ceramic multilayered component, comprising:
providing a first ceramic layer;
forming a first internal electrode over the first ceramic layer;
forming a second ceramic layer over the first internal electrode;
forming a second internal electrode over the second ceramic layer;
applying a third ceramic layer over the second internal electrode;
forming a first via electrode to the first internal electrode;
forming a second via electrode to the second internal electrode;
forming a first connection contact of the first via to contact the first internal electrode; and
forming a second connection contact of the second via to contact the second internal electrode.

24. The method according to claim 23, wherein:
the first via electrode is formed through the first ceramic layer to the first internal electrode; and
the second via electrode is formed through the third ceramic layer to the second internal electrode.

25. The method according to claim 23, wherein forming the first and second via electrodes comprises:
stamping cutouts into the first and third ceramic layers; and
filling the cutouts with an electrically conductive material.

26. The method according to claim 23, comprising removing a part of a layer stack that includes the first, second and third ceramic layers, the part being removed after forming the connection first and second contacts.

27. The method according to claim 26, wherein the part of the layer stack is removed in a manner dependent on a predefined property of the component.
